(19) United States
(12) Patent Application Publication
(10) Pub. No.: US 2016/0175790 A1
(43) Pub. Date: Jun. 23, 2016

(54) CONTAINER AGITATING SYSTEM

(71) Applicants: James McCarley, Gatesvile, TX (US); Billy McCarley, Gatesville, TX (US)

(72) Inventors: James McCarley, Gatesvile, TX (US); Billy McCarley, Gatesville, TX (US)

(21) Appl. No.: 14/573,758

(22) Filed: Dec. 17, 2014

(51) Int. Cl. B01F 11/00

(52) U.S. Cl. CPC B01F 11/0005

(57) ABSTRACT

A container agitating system for includes a base that has a first end, a second end and a peripheral edge extending therebetween. The peripheral edge has a first lateral side and a second lateral side. A pair of rails is attached to and extends upwardly from the base. A carriage is movably mounted on the rails and is positioned within the agitating compartment. The carriage may retain a container. A motor is mounted on the base. A wheel is mechanically coupled to the motor. The wheel has an axis of rotation oriented perpendicular to a line extending through the carriage and motor. A rod has a first end and a second end. The first end of the rod is coupled to the carriage and the second end is coupled to the wheel. The carriage is oscillated forwardly and rearwardly on the base when the motor rotates the wheel.

### BACKGROUND OF THE DISCLOSURE

### Field of the Disclosure

The disclosure relates to agitating devices and more particularly pertains to a new agitating device for mixing contents of a container.

### SUMMARY OF THE DISCLOSURE

An embodiment of the disclosure meets the needs presented above by generally comprising a base that has a first end, a second end and a peripheral edge extending therebetween. The peripheral edge has a first lateral side and a second lateral side. A pair of rails is attached to and extends upwardly from the base. A carriage is movably mounted on the rails and is positioned within the agitating compartment. The carriage may retain a container within the agitating compartment. A motor is mounted on the base. A wheel is mechanically coupled to the motor. The wheel is rotated when the motor is turned on. The wheel has an axis of rotation oriented perpendicular to a line extending through the carriage and motor. A rod has a first end and a second end. The first end of the rod is coupled to the carriage and the second end is coupled to the wheel. The carriage is oscillated forwardly and rearwardly on the base when the motor rotates the wheel.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a container agitating system according to an embodiment of the disclosure.

FIG. 2 is a top view of an embodiment of the disclosure.

FIG. 3 is a right side view of an embodiment of the disclosure.

FIG. 4 is a cross sectional view taken along line 4-4 of FIG. 3 of an embodiment of the disclosure.

FIG. 5 is a front view of an embodiment of the disclosure.

### DESCRIPTION OF THE PREFERRED EMBODIMENT

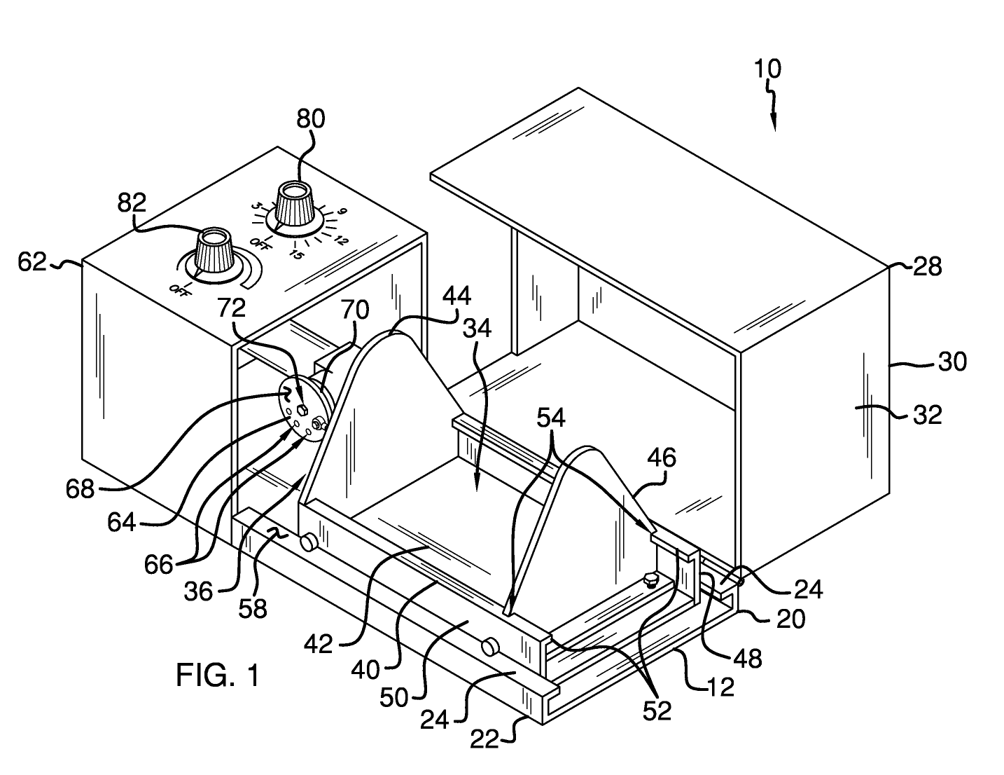

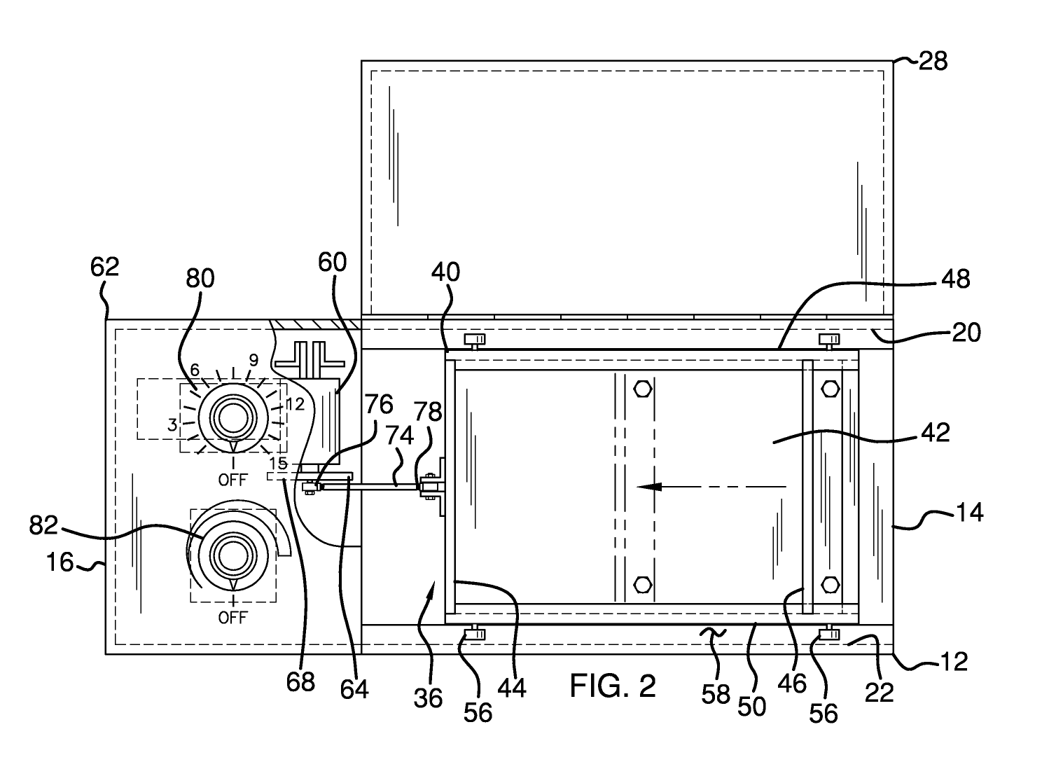

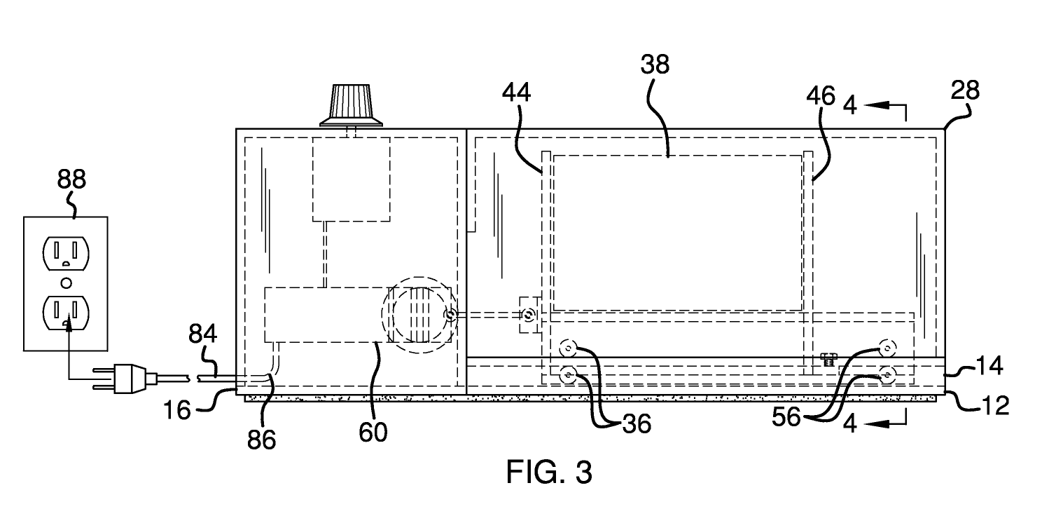

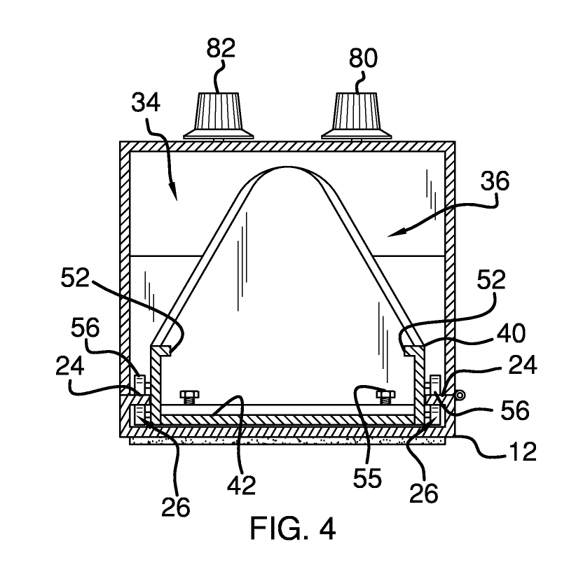

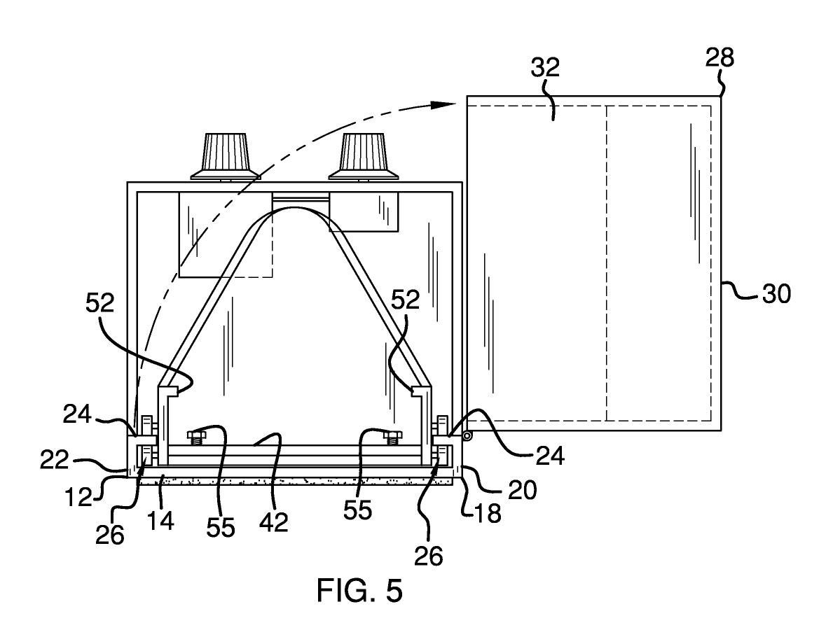

With reference now to the drawings, and in particular to FIGS. 1 through 5 thereof, a new agitating device embodying the principles and concepts of an embodiment of the disclosure and generally designated by the reference numeral 10 will be described.

As best illustrated in FIGS. 1 through 5, the container agitating system 10 generally comprises a base 12 that has a first end 14, a second end 16 and a peripheral edge 18 extending therebetween. The peripheral edge 18 has a first lateral side 20 and a second lateral side 22. A pair of rails 24 is attached to and extends upwardly from the base 12. Each of the first 20 and second 22 lateral sides has one of the rails 24 attached thereto. Each of the rails 24 includes a channel 26 facing another one of the rails 24. Each of the rails 24 extends from the second end 16 to the first end 14.

A lid 28 has a top wall 30 and a perimeter wall 32 extending downwardly therefrom. The lid 28 is hingedly coupled to the base 12 adjacent to the second lateral side 22. The lid 28 is positioned adjacent to the first end 14. The lid 28 is removably positionable over a portion of the base 12 adjacent to the first end 14 to define an agitating compartment 34. The lid 28 is positionable in an open position to access the agitating compartment 34.

A carriage 36 is movably mounted on the rails 24 and is positioned within the agitating compartment 34. The carriage 36 may retain a container 38 within the agitating compartment 34. The container 36 may be a paint can or other similar cylindrically shaped container 36. The carriage 36 includes a frame 40 that has a bottom wall 42, a first end wall 44, a second end wall 46, a first lateral wall 48 and a second lateral wall 50. The first 44 and second 46 end walls each extend between the first 48 and second 50 lateral walls.

The second end wall 46 is positioned adjacent to the second end 16. The first 48 and second 50 lateral walls are each positioned adjacent to one of the first 20 and second 22 lateral sides. The second end wall 46 is movable toward or away from first end wall 44. Each of the first 48 and second 50 lateral walls includes a shoulder 52 extending into one of a pair of notches 54 in the second end wall 46. A fastener 55 extends through the second end wall 46 and releasably engages the bottom wall 42 to secure the second end wall 46 at a selected position.

A plurality of rollers 56 is rotatably coupled to and extends laterally away from the frame 40. Each of the first 48 and second 50 lateral walls has at least two of the rollers 56 mounted thereon. Each of the channels 26 has at least one of the rollers 56 positioned therein. Each of the rails 24 has one of the rollers 56 positioned on an upper surface 58 thereof.

A motor 60 is mounted on the base 12 adjacent to the first end 14. The motor 60 may be an electrical motor or the like. A housing 62 is attached to the base 12 and is positioned over the motor 60. A wheel 64 is mechanically coupled to the motor 60. The wheel 64 is rotated when the motor 60 is turned on. The wheel 64 has an axis of rotation oriented perpendicular to the rails 24.

The wheel 64 has a plurality of apertures 66 extending therethrough. The apertures 66 are positioned on a side surface 68 of the wheel 64 at different distances from the axis of rotation. The apertures 66 are sequentially arranged to form an arc extending between an outer edge 70 and a center 72 of the wheel 64.

A rod 74 has a first end 76 and a second end 78. The first end 76 of the rod 74 is coupled to the first end wall 44 and the second end 78 is coupled to the wheel 64. The carriage 36 is oscillated forwardly and rearwardly on the base 12 when the motor 60 rotates the wheel 64. The second end 78 is removably engaged to one of the apertures 66 to alter a stroke length of the rod 74.

A time control 80 is operationally coupled to the motor 60 to power the motor 60 for a selectable amount of time. A speed control 82 is operationally coupled to the motor 60 to control a selected speed of the motor 60. Each of the time 80 and speed 82 controls are positioned on the housing 62.

A power supply 84 is electrically coupled to the motor 60. The power supply 84 comprises a cord 86 extending away from the housing 62. The cord 86 may be electrically coupled to a power source 88. The power source 88 may be an electrical outlet or the like.

In use, the container 38 is positioned on the carriage 36 and the second end wall 46 is positioned to retain the container 38 on the carriage 36. The lid 28 is closed. The time control 80 is set to the selected amount of time. The speed control 82 is set to determine a rotational speed of the motor 60. The container 38 is removed after the time control 80 de-actuates the motor 60.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A container agitating system configured to retain and agitate a container thereby mixing contents of the container, said assembly comprising:
a base having a first end, a second end and a peripheral edge extending therebetween, said peripheral edge having a first lateral side and a second lateral side;
a pair of rails being attached to and extending upwardly from said base;
a carriage being movably mounted on said rails and being positioned within said agitating compartment, said carriage being configured to retain a container within said agitating compartment;
a motor mounted on said base;
a wheel mechanically coupled to said motor, said wheel being rotated when said motor is turned on, said wheel having an axis of rotation oriented perpendicular to a line extending through said carriage and motor; and
a rod having a first end and a second end, said first end of said rod being coupled to said carriage and said second end being coupled to said wheel such that said carriage is oscillated forwardly and rearwardly on said base when said motor rotates said wheel.

2. The container agitating system according to claim 1, wherein each of said first and second lateral sides having one of said rails attached thereto, each of said rails including a channel facing another one of said rails, each of said rails extending from said second end to said first end.

3. The container agitating system according to claim 1, further including a lid having a top wall and a perimeter wall extending downwardly therefrom, said lid being hingedly coupled to said base adjacent to said second lateral side, said lid being positioned adjacent to said first end, said lid being removably positionable over a portion of said base adjacent to said first end to define an agitating compartment, said lid being positionable in an open position to access said agitating compartment, said carriage being positioned in said agitating compartment.

4. The container agitating system according to claim 1, said carriage including:
a frame having a bottom wall, a first end wall, a second end wall, a first lateral wall and a second lateral wall, said first and second end walls each extending between said first and second lateral walls, said second end wall being positioned adjacent to said second end, said first and second lateral walls each being positioned adjacent to one of said first and second lateral sides, said second end wall being movable toward or away from said bottom wall, each of said first and second lateral walls including a shoulder extending into one of a pair of notches in said second end wall; and
a plurality of rollers being rotatably coupled to and extending laterally away from said frame, each of said first and second lateral walls having at least two of said rollers mounted thereon, said rollers each engaging one of said rails.

5. The container agitating system according to claim 4, further including a fastener extending through said second end wall and releasably engaging said bottom wall to secure said second end wall at a selected position.

6. The container agitating system according to claim 2, said carriage including:
a frame having a bottom wall, a first end wall, a second end wall, a first lateral wall and a second lateral wall, said first and second end walls each extending between said first and second lateral walls, said second end wall being positioned adjacent to said second end, said first and second lateral walls each being positioned adjacent to one of said first and second lateral sides, said second end wall being movable toward or away from said first end wall, each of said first and second lateral walls including a shoulder extending into one of a pair of notches in said second end wall; and
a plurality of rollers being rotatably coupled to and extending laterally away from said frame, each of said first and second lateral walls having at least two of said rollers mounted thereon, each of said channels having at least one of said rollers positioned therein, each of said rails having one of said rollers positioned on an upper surface thereof.

7. The container agitating system according to claim 6, further including a fastener extending through said second end wall and releasably engaging said bottom wall to secure said second end wall at a selected position.

8. The container agitating system according to claim 1, a housing being attached to said base and being positioned over said motor.

9. The container agitating system according to claim 1, wherein:
said wheel having a plurality of apertures extending therethrough, said apertures being positioned on a side surface of said wheel at different distances from said axis of rotation, said apertures being sequentially arranged to form an arc extending between an outer edge and a center of said wheel;
said second end being removably engaged to one of said apertures to alter a stroke length and said rod.

10. The container agitating system according to claim 1, further including a time control being operationally coupled to said motor to power said motor for a selectable amount of time.

11. The container agitating system according to claim 1, further including a speed control being operationally coupled to said motor to control a selected speed of said motor.

12. A container agitating system configured to retain and agitate a container thereby mixing contents of the container, said assembly comprising:
a base having a first end, a second end and a peripheral edge extending therebetween, said peripheral edge having a first lateral side and a second lateral side;
a pair of rails being attached to and extending upwardly from said base, each of said first and second lateral sides having one of said rails attached thereto, each of said rails including a channel facing another one of said rails, each of said rails extending from said second end to said first end;
a lid having a top wall and a perimeter wall extending downwardly therefrom, said lid being hingedly coupled to said base adjacent to said second lateral side, said lid being positioned adjacent to said first end, said lid being removably positionable over a portion of said base adjacent to said first end to define an agitating compartment, said lid being positionable in an open position to access said agitating compartment;
a carriage being movably mounted on said rails and being positioned within said agitating compartment, said carriage being configured to retain a container within said agitating compartment, said carriage including:
a frame having a bottom wall, a first end wall, a second end wall, a first lateral wall and a second lateral wall, said first and second end walls each extending between said first and second lateral walls, said second end wall being positioned adjacent to said second end, said first and second lateral walls each being positioned adjacent to one of said first and second lateral sides, said second end wall being movable toward or away from said first end wall, each of said first and second lateral walls including a shoulder extending into one of a pair of notches in said second end wall, a fastener extending through said second end wall and releasably engaging said bottom wall to secure said second end wall at a selected position;
a plurality of rollers being rotatably coupled to and extending laterally away from said frame, each of said first and second lateral walls having at least two of said rollers mounted thereon, each of said channels having at least one of said rollers positioned therein, each of said rails having one of said rollers positioned on an upper surface thereof;
a motor mounted on said base adjacent to said first end;
a housing being attached to said base and being positioned over said motor;
a wheel mechanically coupled to said motor, said wheel being rotated when said motor is turned on, said wheel having an axis of rotation oriented perpendicular to said rails, said wheel having a plurality of apertures extending therethrough, said apertures being positioned on a side surface of said wheel at different distances from said axis of rotation, said apertures being sequentially arranged to form an arc extending between an outer edge and a center of said wheel;
a rod having a first end and a second end, said first end of said rod being coupled to said first end wall and said second end being coupled to said wheel such that said carriage is oscillated forwardly and rearwardly on said base when said motor rotates said wheel, said second end being removably engaged to one of said apertures to alter a stroke length and said rod;
a time control being operationally coupled to said motor to power said motor for a selectable amount of time;
a speed control being operationally coupled to said motor to control a selected speed of said motor; and
a power supply being electrically coupled to said motor, said power supply comprising a cord extending away from said housing, said cord being configured to be electrically coupled to a power source.
